(19) United States
(12) Patent Application Publication
(10) Pub. No.: US 2011/0284529 A1
(43) Pub. Date: Nov. 24, 2011

(54) Microwave Alarm Clock

(76) Inventor: Ryan A. Karns, Loves Park, IL (US)

(21) Appl. No.: 12/723,662

(22) Filed: May 19, 2010

(51) Int. Cl. H05B 6/68

(52) U.S. Cl. 219/719

(57) ABSTRACT

One embodiment consisting of food conservation units including cooling elements such as peltier units 30, fan 31, and vacuum 32. Embodiment also includes microwave components such as HV transformer/diode 71, capacitor 70, magnetron 25, vent hood 21, and stirrer 22 allowing food in compartment 20 to be cooked. These components are managed by front LCD head unit 10, turn click knob 13, and quick menu buttons 11-12. Embodiment is accessible through transparent microwave proof hinged door and can be made of multiple materials and in a variety of sizes and colors. Other components are described and shown.

### ADVANTAGES

Accordingly several advantages of one or more aspects are as follows: easy way to prepare breakfast, able to save time the next morning, can be produced in variety of sizes and colors, combines two commonly known appliances microwave and alarm clock, able to be produced affordably, and allows consumer to sleep in later and still prepare breakfast. Other advantages of one or more aspects will be apparent from a consideration of the drawings and ensuing descriptions.

### BRIEF DESCRIPTION OF DRAWINGS

FIG. 1 depicts a front 3D view of housing 60 including an overview of the cooling/vacuum units located under food compartment 20 and alarm clock display unit.

FIG. 2 shows a closer front 3D view of the cooling/vacuum units including the microwave stirrer and power source.

FIG. 3 displays a 3D view from the back at the power switch between cooling/vacuum units to transformer/diode to magnetron where microwaves will then be transferred to food compartment 20 and also speaker connection to head unit 10

FIG. 4 provides a bird's eye view of housing unit 60 with an overview of baking components and also head unit components including speaker

FIG. 5 is a flow chart showing the switch of power from food preservation mode including cooling/vacuum units to baking mode including stirrer, transformer/diode, magnetron, and hood vent.

### INVENTION BRIEF DESCRIPTION

This invention is a combination of a microwave, alarm clock, and a food conservation unit. This allows the consumer to place food in unit before going to sleep and have the unit conserve the food overnight. This conservation unit will include peltier units and fan to keep contents at a stable cool temperature. This LCD unit will include user friendly buttons and turn dial that will allow consumer to change microwave settings, sound notification output, and other alarm clock settings. At the desired time of wake up the unit will begin cooking food contents and then relay message, at time of completion, to alarm clock LCD head unit. This message will then be sent to a speaker which will then wake up consumer using a variety of sound notifications.

### DETAILED INVENTION DESCRIPTION

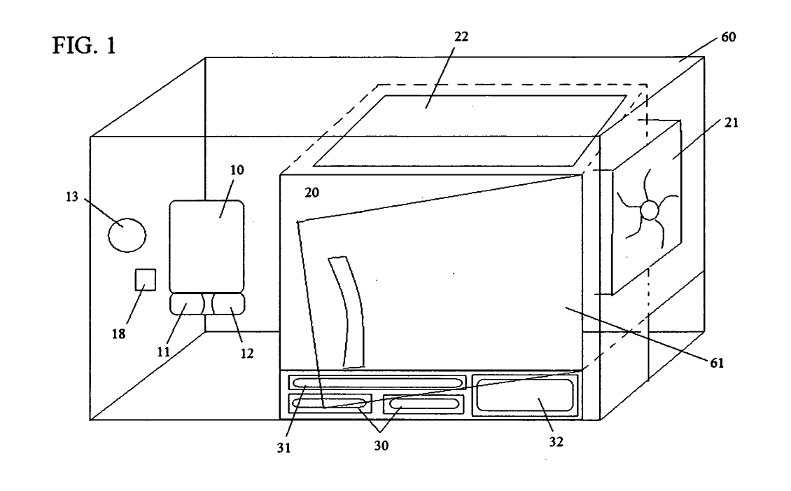

FIG. 1 depicts a front loading embodiment of a Microwave Alarm Clock. A housing unit 60 encloses a sealable compartment 20, which is enclosed by a front opening door 61. Microwavable foods are stored in compartment 20. The compartment will be vacuum sealed and cooled to increase the shelf life of the foodstuffs. This will become important since the foods will be left in the compartment primarily overnight. To provide visibility without having to first access the compartment, all or a portion of door 61 may be made transparent, e.g., using glass, plastic, or the like. Volume of compartment 20 may be small for bedside alarm clock units, e.g., perhaps 0.2 ft.sup.3 or so, or may be made substantially larger for normal size kitchen appliance use.

Within compartment 20, a negative pressure (or vacuum) environment of about 10″ Hg and at least 60% relative humidity maintained. This environment is created by a vacuum pump (or equivalent) 32, located within the microwave alarm clock 60. A variety of vacuum pump type units may be used for unit 32, including roller within-a-tube pumps.

Chamber 20 will also be made coolable, with peltier units located within compartment 30. These peltier units will be especially economical and efficient. Compartment 31 will contain a fan which will also be used with the peltier units to cool compartment 20.

Compartment 20 will also contain microwave stirrer 22 to spread microwave waves produced by the magnetron 25. A side mounted microwave vent hood 21 will be used to clear compartment 20 after baking. This will be explained further in FIG. 3 description.

Located on the front of the microwave alarm clock embodiment 60 will be alarm clock/microwave LCD 10 controlled by turn-click dial 13 and quick menu buttons 11 and 12.

Quick buttons may include options such as hour and minute settings for alarm clock options or start and cancel buttons for microwave options. The alarm clock/microwave LCD will be able to control multitudes of controls such as volume, radio tuner, microwave power level, preset alarm times, etc. This turn-click dial 13, alarm clock/microwave LCD 10 and quick menu buttons 11 and 12, will provide unit 60 with easy to use functionality for the consumer.

Optionally, LCD head unit 10 may contain radio and/or auxiliary input for leisure listening or to play as notification that baking is complete.

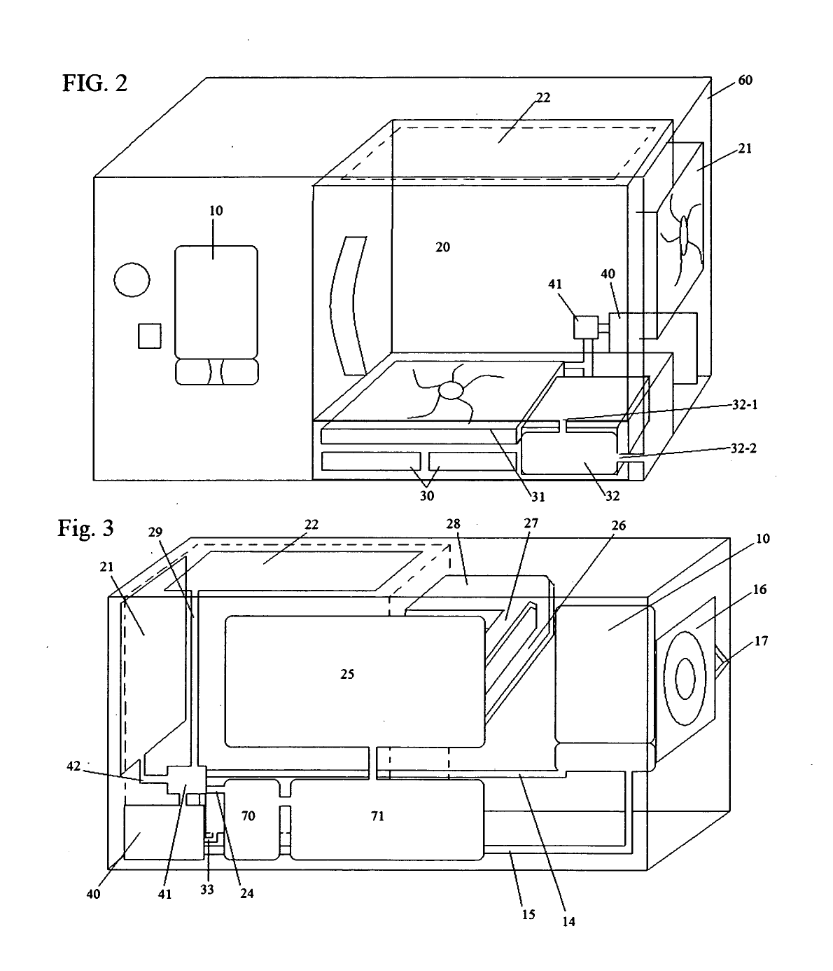

In FIG. 2 peltier units 30 will provide compartment 20 with temperatures 40 degrees Fahrenheit or lower. This will increase the shelf life of the foodstuffs to allow consumer to leave food in microwave alarm clock overnight. Above peltier units 30 will be a fan 31 to spread cooling temperatures throughout compartment 20.

Within compartment 32 is a vacuum as stated in FIG. 1 description. This vacuum will also increase shelf life of the foods so they may be left in compartment 20 overnight. Vacuum pump 32 draws air from chamber 20 via one or more input ports 32-1 and exhausts the air via one or more output ports 32-2 e.g., in a sidewall of housing 60.

Once front loading door 61 is closed night conservation mode¹ consisting of Peltier units 30, peltier unit fan 31, and vacuum 32 may be activated by alarm clock/microwave LCD 10. Upon this activation, power supply is transferred to units 30, 31, and 32 allowing you to preserve goods in compartment 20 until morning bake mode.² ¹ Night Conservation Mode- activation of pettier units 30, peltier unit fan 31, and vacuum 32 in order to preserve food stored in compartment 20 until preset baking time set by LCD head unit 10.² Morning Bake Mode-power switch from night conservation mode to microwave HV transformer/diode 71, capacitor 70, magnetron 25, vent hood 21, and stirrer 22 allowing food in compartment 20 to be cooked

Energizing power for the present invention is provided by power source 40 which may be a conventional house current, or AC: DC power unit. This power current will be controlled by microprocessor unit (CPU) 41 which will be directed by alarm clock/microwave LCD 10. This will be further explained in FIG. 3 description.

Located on top of compartment 20 is microwave stirrer unit 22 which is used to spread microwaves throughout compartment 20. This stirrer allows food to be cooked evenly without use of a conveyor system in compartment 20. Located on the side of unit 60 is a side mounted vent hood 21 to clear compartment 20. This concept is also found in conventional microwaves. However, this side mounted vent hood 21 will be considerably smaller than conventional microwaves due to the size of compartment 20.

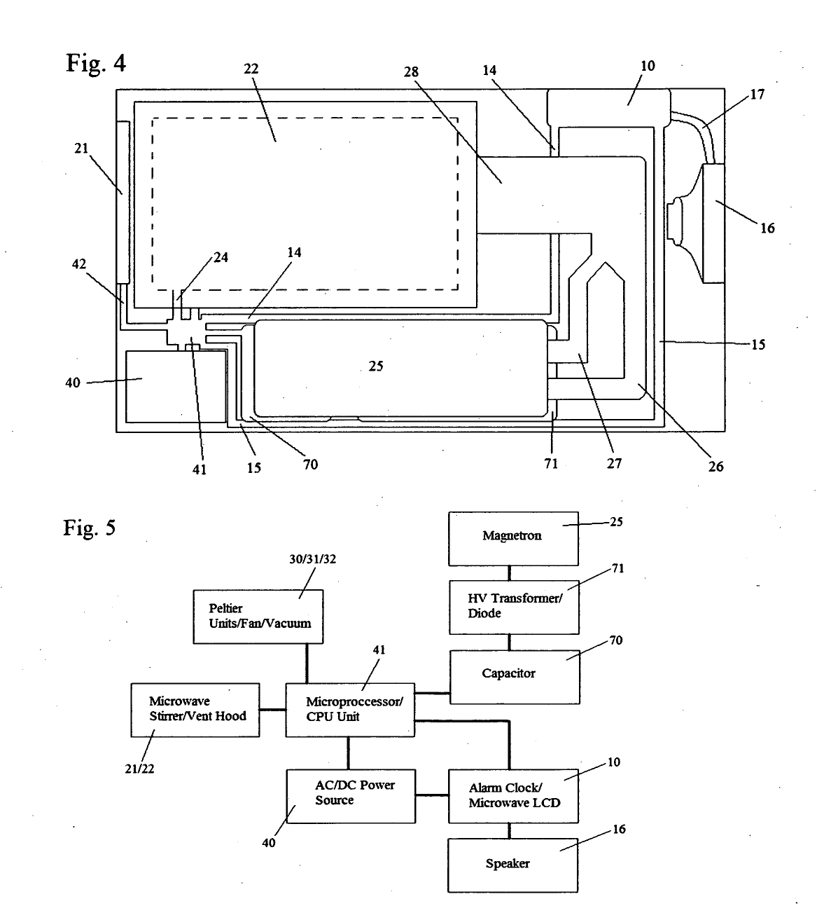

In FIGS. 3 and 4 power supply 40 is conducted to microprocessor unit (CPU) 41 which will switch the power supply from night conservation mode, consisting of peltier units 30, peltier unit fan 31, and vacuum 32, to morning baking mode consisting of microwave capacitor 70, HV transformer/diode 71, magnetron 25, stirrer 22, and vent hood 21, while keeping a constant power supply to alarm clock/microwave LCD 10. This power switch is directed by the alarm clock/microwave LCD 10 to the microprocessor unit (CPU) 41 at the designated preset alarm clock time setting.

Power supply 40 will transfer power to capacitor 70 that will then transfer AC power from microprocessor unit 41 to diode and HV transformer 71 to convert to high voltage. This high voltage is then sent to magnetron 25 which will contain two magnetron oscillators that translates microwaves through wave length guides 26 and 27 where the microwaves will then converge in chamber 28 and be pushed into compartment 20.

16 Microwave stirrer 22 and also microwave vent hood 21 power supply will also be transferred from power supply 40 to microprocessor unit (CPU) 41 and then through conductors 29 and 42 upon activation of morning baking mode at preset alarm clock time setting.

Alarm clock/microwave LCD 10 will have a constant power supply through conductor 14 from microprocessor unit (CPU) 41. Upon activation of morning baking mode information will be relayed from alarm clock/microwave LCD 10 through conductor 15 back to microprocessor unit 41 where the power supply may then be switched from peltier units 30, peltier unit fan 31, and vacuum 32 to microwave capacitor 70, diode and HV transformer 71, magnetron 25, stirrer 22, and vent hood 21. After baking is complete power will be transferred through conductor 17 to microwave alarm speaker at which it will beep to notify consumer that baking is complete. This beep includes a variety of notifications such as FM radio, auxiliary input, and other tone notifications that will primarily be used to wake-up the consumer. This concept is found in most traditional microwaves.

FIG. 5. Represents a control circuit that portrays the power switch between microwave components and night conservation mode. The night conservation mode will be activated through the alarm clock/microwave LCD 10 by setting preset alarm time. This will then send a signal to microprocessor unit (CPU) 41 which will then send power to peltier units 30, peltier unit fan 31, and vacuum 32. This will allow the food to be preserved until preset alarm clock time. Once this preset time is reached morning bake mode will be activated by alarm clock/microwave LCD 10 sending signal to CPU 41 to switch power to microwave vent hood 21 and stirrer 22. This will also send power to capacitor 70 which will then be transferred into high voltage by diode and HV transformer 71 which will then be sent to Magnetron 25. After this baking process is complete alarm clock/microwave LCD 10 will send signal to speaker 16 which will then release notification sound via radio, auxiliary, or other sound notification output.

1. I claim a food cooking and preservation embodiment, comprising:
a. Housing that contains microwave oven components needed to generate microwaves used to cook food
b. cooling units using a fan will cool said food compartment and,
c. vacuum unit used to create negative pressure within said compartment will allow food to be safely preserved
d. alarm clock like display unit that enables said unit to preserve food or begin bake mode at preset times
